(19) United States
(12) Patent Application Publication
(10) Pub. No.: US 2026/0299915 A1
(43) Pub. Date: Oct. 1, 2026

(54) CONTAINER IMAGE OPTIMIZATION TO ACCELERATE CONTAINER DEPLOYMENT

(71) Applicant: INTERNATIONAL BUSINESS MACHINES CORPORATION, ARMONK, NY (US)

(72) Inventors: Yu Zui You, Ningbo (CN); Xiao Ling Chen, Beijing (CN); Heng Wang, Beijing (CN); Xinpeng Liu, Austin, TX (US)

(21) Appl. No.: 19/097,090

(22) Filed: Apr. 1, 2025

(51) Int. Cl. G06F 8/61; G06F 11/14; G06F 11/30; G06F 16/901

(52) U.S. Cl. CPC G06F 8/63; G06F 11/14; G06F 11/301; G06F 16/9024

(57) ABSTRACT

Described are techniques for container deployment acceleration. The techniques include extracting information from layers of an initial container image in the form of a set of nodes. The techniques further include building an image-layer analysis graph to represent relationships between nodes in the set of nodes. The techniques further include identifying adjustments to the image-layer analysis graph that, when applied to the initial container image, are expected to improve a containerized application deploy-time. The techniques further include building an optimized container image according to the adjustments identified for the image-layer analysis graph, and deploying a primary containerized application using the optimized container image and a secondary containerized application using the initial container image, where the secondary containerized application serves as a backup to the primary containerized application.

### BACKGROUND

The present disclosure relates to container deployment acceleration. Container technology has become increasingly popular for deploying and running applications in cloud and enterprise environments. Containers provide a lightweight, portable, and isolated runtime environment that packages an application along with its dependencies. This allows applications to run consistently across different computing environments.

A key component of container technology is the container image, which contains the files, libraries, and dependencies needed to run an application. Container images are typically built in layers, with a base operating system layer and additional layers for application code and dependencies. When deploying containers at scale, the size and structure of these container images can have a significant impact on deployment speed and resource utilization.

### SUMMARY

According to an aspect of the present disclosure, a computer-implemented method is provided. The method includes extracting information from the layers of an initial container image in the form of a set of nodes. The method further comprises building an image-layer analysis graph to represent relationships between nodes in the set of nodes. The method further comprises identifying adjustments to the image-layer analysis graph that, when applied to the initial container image, are expected to improve a containerized application deploy-time. The method further comprises building an optimized container image according to the adjustments identified for the image-layer analysis graph, and deploying a primary containerized application using the optimized container image, and deploying a secondary containerized application using the initial container image to serve as a backup to the primary containerized application.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE FIGURES

The figures included in the present application are incorporated into and form part of the specification. They illustrate embodiments of the present disclosure and, along with the description, serve to explain the principles of the disclosure. The figures are only illustrative of certain embodiments and do not limit the disclosure.

FIG. 1 illustrates a block diagram of a dynamic image layer optimization system, in accordance with some embodiments of the present disclosure.

FIGS. 2A-2B illustrate block diagrams of a dynamic image-layer analysis module and associated processing, in accordance with some embodiments of the present disclosure.

FIGS. 3A-3B illustrate block diagrams of a dynamic image-layer adjustment module and associated processing, in accordance with some embodiments of the present disclosure.

FIG. 4 is a flow diagram illustrating a method for container deployment acceleration, in accordance with some embodiments of the present disclosure.

FIG. 5 is a flow diagram illustrating a method for validating an optimized container image, in accordance with some embodiments of the present disclosure.

FIG. 6 illustrates a block diagram of an example computing environment in which aspects of the present disclosure can be implemented, in accordance with some embodiments of the present disclosure.

While the present disclosure is amenable to various modifications and alternative forms, specifics thereof have been shown by way of example in the figures and will be described in detail. It should be understood, however, that the intention is not to limit the present disclosure to the particular embodiments described. On the contrary, all modifications, equivalents, and alternatives are within the spirit and scope of the present disclosure.

### DETAILED DESCRIPTION

Aspects of the present disclosure are directed toward container deployment acceleration. While not limited to such applications, embodiments of the present disclosure may be better understood in light of the following context.

As container adoption has grown, organizations are deploying larger numbers of containerized applications across distributed environments. This has led to challenges around optimizing containers for accelerated deployments. Container deployment acceleration, as used herein, refers to the process of deploying a containerized application using an optimized container image to decrease an amount of time to deploy the containerized application into a production environment (an operational space where the containerized application is accessible to end-users).

Existing approaches to container deployment often involve pulling and extracting full container images, which can be time-consuming and resource-intensive, especially for large images or when deploying many containers simultaneously. For example, as organizations scale their containerized applications, several challenges emerge related to image size and deployment efficiency. The size of a container image directly impacts deployment speed, resource utilization, and overall system performance. That is, pulling large container images from repositories to deployment targets can result in longer deployment times, potentially causing delays in application startup and reducing overall system responsiveness. Furthermore, the time required to extract and load containerized applications into memory from large container images can also impact deployment speed. This process may consume substantial computational resources, potentially affecting the performance of other applications or services running on the same host system. This issue may be particularly pronounced in distributed environments or when deploying across wide area networks with limited bandwidth.

Container images can include unnecessary components, libraries, or files that are not utilized by a respective containerized application. These superfluous elements not only increase image size but can also introduce potential security vulnerabilities or complicate image maintenance. Traditional approaches to addressing container image issues often involve manual optimization of container files or careful selection of a base image. However, these methods may require significant expertise and time investment from developers. Additionally, manual optimization efforts may not always yield consistent results across different applications or deployment scenarios. Moreover, redundancies between container images, such as common base layers or libraries, are not always efficiently handled. Existing automated tools for image acceleration are limited in handling complex applications with intricate dependencies. These tools can produce irreversible changes to container images, potentially introducing risks in production environments or complicating debugging processes.

The challenges above underscore the need for advanced solutions that can intelligently analyze, optimize, and manage container images to accelerate container deployment. Advantageously, aspects of the present disclosure improve container deployment by way of intelligent analysis and modification of an initial (original) container image to create an optimized container image, and to deploy, both, a primary containerized application using the optimized container image, and a secondary containerized application using the initial (unoptimized) container image to serve as a backup to the primary containerized application. This approach safeguards against potential issues that may arise from the optimization process. Accordingly, aspects of the present disclosure can involve analyzing the structure of a container image, identifying opportunities for optimization, and implementing modifications to the container image to improve deployment efficiency of a containerized application launched using the modified container image.

As an illustrative example, the optimization process can include extracting information from the layers of an initial container image, and the information can be represented as a set of nodes (graph nodes). The information can include, for example, layer identifiers, file lists, and layer build commands. An image-layer analysis graph can then be constructed using the set of nodes to represent relationships between the layers of the initial container image. Thereafter, adjustments to the image-layer analysis graph can be identified that potentially optimize the initial container image. The adjustments may involve operations that include, but are not limited to, merging layers, removing redundant data, and/or restructuring the container image to improve efficiency. An objective of the adjustments, among other things, is to reduce the size of the initial container image, thereby potentially leading to a reduced containerized application deploy-time that accelerates deployment of the containerized application.

After identifying the adjustments, an adjustment plan is implemented. The adjustment plan comprises operations that correspond to the identified adjustments, which are performed on the initial container image to create an optimized container image. Illustratively, the operations can include rebuilding image layers, consolidating redundant files, and implementing a slim base layer (a minimal, lightweight base image layer).

After creating the optimized container image, container deployment can be accelerated by deploying a primary containerized application using the optimized container image. More specifically, because the optimized container image has been constructed using the identified adjustments to the initial container image, which reduce image size and improve image layering for faster builds of containerized applications, deploying the primary containerized application using the optimized container image accelerates the deployment process. As a safeguard to this automated process, a secondary containerized application is deployed using the initial container image to serve as a backup to the primary containerized application. That is, should the primary containerized application fail to meet performance thresholds, operations performed by the primary containerized application can be switched over to the secondary containerized application to ensure continuity of service. Accordingly, monitoring is performed to assess the performance of the primary containerized application. By employing this comprehensive approach to container image analysis, container image optimization, and deployment, aspects of the present disclosure address challenges associated with large-scale container deployments, thereby improving efficiency and resource utilization in containerized environments.

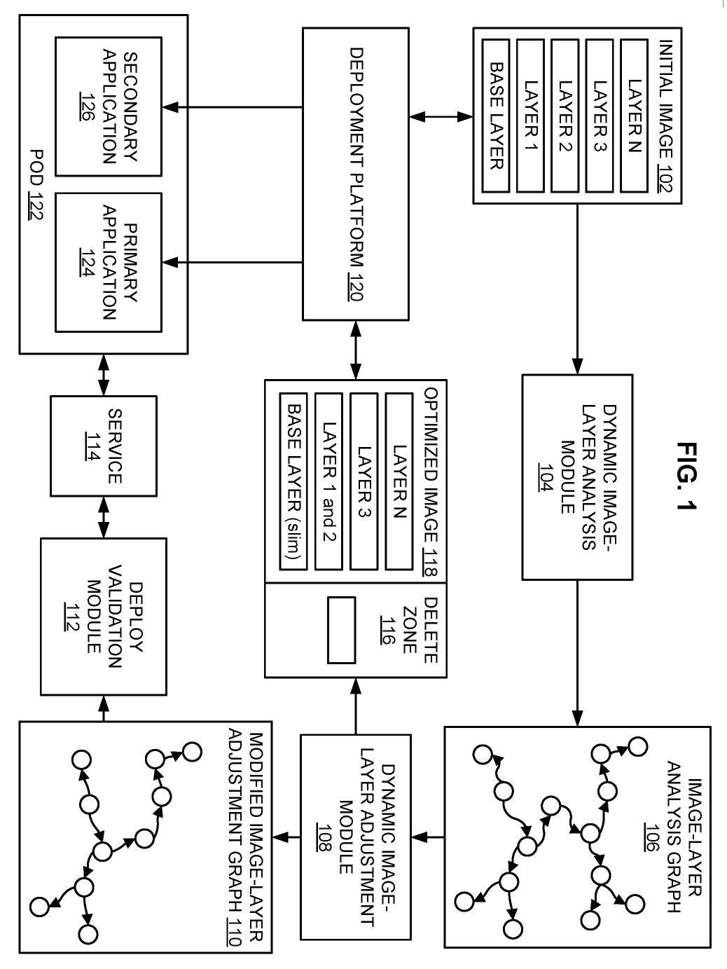

FIG. 1 illustrates a block diagram of an example container image optimization and deployment system. The system comprises several interconnected components that work together to analyze, optimize, and deploy container images efficiently. As shown, the system includes a dynamic image-layer analysis module 104, a dynamic image-layer adjustment module 108, a deploy validation module 112, and other components as appreciated by persons of ordinary skill.

The container image optimization and deployment system in FIG. 1 begins with an initial container image (shown as initial image 102), which contains multiple layers arranged in a hierarchical structure. As shown, the initial image 102 can include a base layer and additional layers 1-N (collectively layers, where N can refer to any positive integer representing any number of layer).

As background, a container image is a static file (e.g., a Dockerfile) that contains everything needed to run the containerized application, including the application code, libraries, dependencies, and the runtime environment. The layers of the container image act as a blueprint for creating a containerized application. The base layer of the container image comprises a foundational read-only layer that typically contains an operating system or a minimal runtime environment. The other layers of the container image are built upon the base layer. Each layer can contain a set of filesystem changes, such as additions, deletions, or modifications. As a simplified example, a first layer may add basic commands and a package manager; a second layer may install a Python® runtime and pip (package manager for Python® packages) for dependency management; a third layer may load an application’s specific requirements.txt file; a fourth layer may install the application’s specific dependencies; and a fifth layer may load the actual source code of the application.

The layers of a container image let other users extend the container image by reusing layers and adding additional layers to include the data that their application needs, which increases the size of the container image. However, the size of a container image is a critical factor in the deployment of containerized applications, especially in environments with large-scale deployments and frequent updates. Not only does a large container image occupy a large amount of storage space, it also can cause a significant increase in deployment time of a respective containerized application, which affects the responsiveness and overall performance of the containerized application. As described in more detail below, these container images can be optimized by removing unnecessary components and dependencies.

The dynamic image-layer analysis module 104 shown in FIG. 1 processes the initial image 102 and generates an image-layer analysis graph 106. The resulting image-layer analysis graph 106 is generated to represent relationships and connections between different container image components through interconnected nodes.

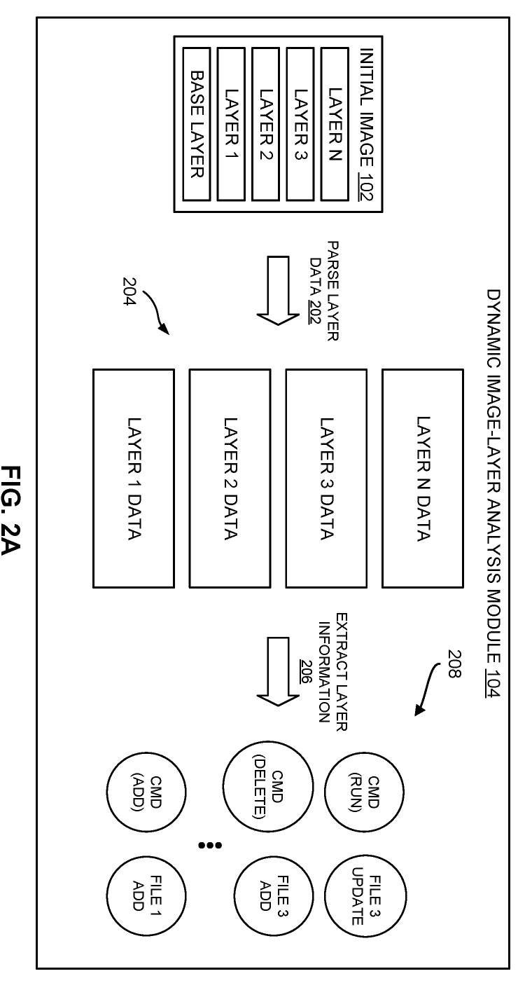

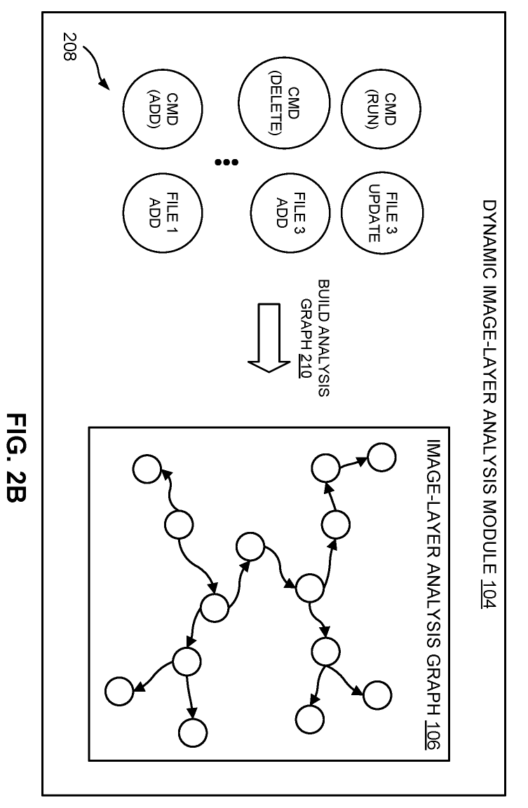

With continued reference to FIG. 1, FIGS. 2A and 2B illustrate example processing performed by the dynamic image-layer analysis module 104 to generate the image-layer analysis graph 106, in accordance with some embodiments of the present disclosure. The dynamic image-layer analysis module 104 performs a comprehensive analysis of the structure and contents of the initial image 102. As illustrated in FIG. 2A, the dynamic image-layer analysis module 104 begins by parsing 202 layer data 204 obtained from each layer of the initial image 102 and extracting 206 detailed information about each layer's composition and characteristics. This information can include: layer identifiers that uniquely distinguish each layer in the initial image 102; file lists associated with each layer that provide a comprehensive inventory of the files contained within; and layer build commands specifying the instructions used to create each layer. As an example, the layer data 204 extracted from the layers includes, but is not limited to, a unique identifier for each layer (e.g., a layer digest, which is a cryptographic hash of the layer's content), a list of files included in each of the layers (e.g., path, size, hash, permissions, etc.) including file change types (add, modify, or delete) and layer build commands (e.g., RUN, COPY, MODIFY, etc.), if extractable.

As part of the extraction process, information obtained from a layer of the initial image 102 can be placed in a node (included in a set of nodes 208), such that the individual node contains details for a particular element (e.g., a file, a command, etc.) included in the layer. As a non-limiting example, details for a command included in a layer of the initial image 102 can be placed in a node, where the details include a command type (e.g., RUN, COPY, MODIFY, etc.), a layer identifier for the layer that contains the command, file information (e.g., path, size, hash, permissions, etc.) for file(s) associated with the command, etc. This process can be performed for each element in a layer, or for a selection of elements in the layer. Moreover, this process can be performed for each layer of the initial image 102, or alternatively, for just a selection of layers of the initial image 102 (e.g., layers selected by a user or selected via programmatic analysis).

After extracting 206 the layer information from the layers of the initial image 102, the dynamic image-layer analysis module 104 proceeds to analyze the layer information. The analysis process involves examining relationships between different elements (e.g., files, commands, etc.) within the initial image structure, including identifying relationships between layers, such as dependencies or inheritance patterns. The dynamic image-layer analysis module 104 also examines relationships between the layers and the files contained within the layers, determining which files are associated with specific layers and how modifications to the files impact the layer structure. Furthermore, the analysis extends to identifying relationships between the individual files, such as shared dependencies or functional connections.

As part of this analysis, the dynamic image-layer analysis module 104 can detect file-level redundancies by comparing file contents across different layers of the initial image 102. Empty layers, which contain no substantive changes or additions, can also be identified during this process. The dynamic image-layer analysis module 104 can also detect intermediate files, such as temporary build artifacts or cached data, by examining file usage patterns across the layers of the initial image 102.

Based on the extracted information in the set of nodes 208 and the analysis results, the dynamic image-layer analysis module 104 builds 210 an image-layer analysis graph 106, as illustrated in FIG. 2B. The image-layer analysis graph 106 represents the relationships between nodes in the set of nodes 208 derived from the layer analysis described above. The nodes in the image-layer analysis graph 106 correspond to the various elements (e.g., files, commands, etc.) and attributes of the layers of the initial image 102. Moreover, the image-layer analysis graph 106 provides a visual representation of the initial image structure, highlighting the interconnections and dependencies between the different elements. The image-layer analysis graph 106 serves as a foundation for subsequent optimization and adjustment processes, allowing for informed decision-making regarding potential modifications to the initial image 102.

The image-layer analysis graph 106 can reveal complex relationships between layers and files that are not immediately apparent from examining the raw data in the layers of the initial image 102. These relationships revealed by the image-layer analysis graph 106 may show file-level redundancies, empty layers, and intermediate files. By representing these relationships in the structured format of the image-layer analysis graph 106, more efficient analysis and optimization of the initial image 102 is facilitated, which enables more targeted and effective adjustments to the initial image 102 that reduce image size and improve deployment efficiency.

Returning to FIG. 1, the dynamic image-layer adjustment module 108 receives the image-layer analysis graph 106 as input and identifies potential adjustments using the information represented in the image-layer analysis graph 106. The dynamic image-layer adjustment module 108 then determines which of these adjustments are expected to accelerate container image deployment. Based on this analysis, the dynamic image-layer adjustment module 108 forms an adjustment plan for modifying the image-layer analysis graph 106 to represent the adjustments are expected to accelerate container image deployment. The dynamic image-layer adjustment module 108 then implements the adjustment plan by modifying the image-layer analysis graph 106 to form a modified image-layer adjustment graph 110. That is, the dynamic image-layer adjustment module 108 applies the adjustments expected to accelerate container image deployment to the image-layer analysis graph 106, thereby creating a modified image-layer adjustment graph 110. The modified image-layer adjustment graph 110 provides a plan or outline for building an optimized image 118 from the initial image 102. For example, based on a correlation between the nodes of the modified image-layer adjustment graph 110 and the layers of the initial image 102, the dynamic image-layer adjustment module 108 builds the optimized image 118 (e.g., by merging and/or deleting layers of the initial image 102).

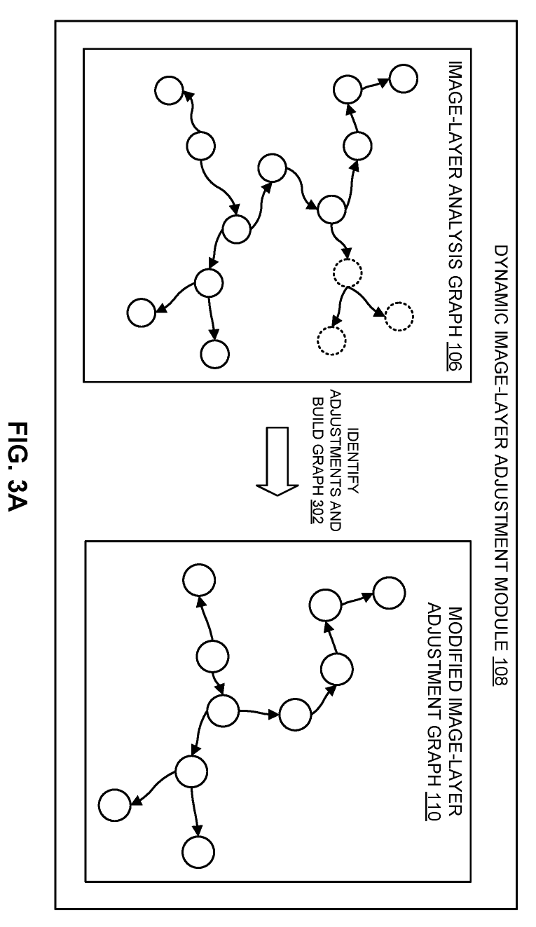

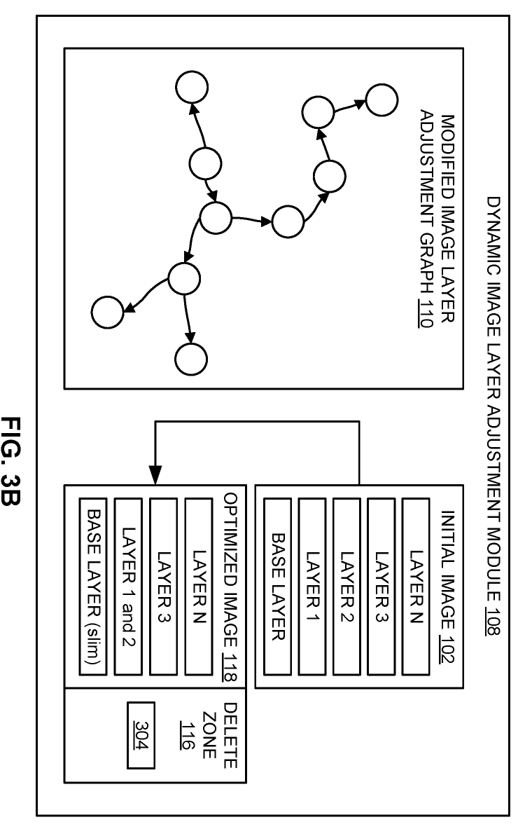

With continued reference to FIG. 1, FIGS. 3A and 3B illustrate example processing performed by the dynamic image-layer adjustment module 108 to generate the modified image-layer adjustment graph 110 and the optimized image 118, in accordance with some embodiments of the present disclosure. As shown in FIG. 3A, the dynamic image-layer adjustment module 108 identifies 302 adjustments to the image-layer analysis graph 106 that are expected to decrease the size of the initial image 102 and accelerate container deployment. The dynamic image-layer adjustment module 108 then applies the adjustments to the image-layer analysis graph 106 by merging, deleting, and/or relinking the nodes representing the various elements and attributes of the initial image layers. Illustratively, the adjustments can comprise removing empty layers, removing duplicate files, removing obsolete files, merging layers, replacing the base layer with a slim base layer version (a minimal, lightweight base image layer), and the like. Applying the adjustments to the image-layer analysis graph 106 forms a modified image-layer adjustment graph 110.

As illustrated in FIG. 3B, the dynamic image-layer adjustment module 108 further creates an optimized image 118 based on the adjustments identified for the modified image-layer adjustment graph 110. The modified image-layer adjustment graph 110 can guide the construction of the optimized image 118. For example, the operations used to build the optimized image 118 can be based on the adjustments applied to the modified image-layer adjustment graph 110. These operations can merge layers, delete layers, relink layers, and/or replace the base layer. Illustratively, the dynamic image-layer adjustment module 108 can identify duplicate files across layers and tag them for consolidation into a single layer. The dynamic image-layer adjustment module 108 can determine that certain layers can be merged or deleted entirely without affecting the functionality of the resulting optimized image 118. The dynamic image-layer adjustment module 108 can perform layer relinking operations to optimize the hierarchical structure of the resulting optimized image 118. The base layer of the initial image 102 can be replaced with a reduced version. For example, a full operating system image can be replaced with a slimmer alternative that provides only the essential components required for operation of a containerized application launched using the optimized image 118.

The dynamic image-layer adjustment module 108 generates an optimized image 118 based on the identified optimization operations that correspond to modified image-layer adjustment graph 110, creating the optimized image 118. In some embodiments, as part of the build process, the dynamic image-layer adjustment module 108 caches deleted files in a designated delete zone 116. This caching allows for potential restoration or further analysis in future optimization attempts, providing a safeguard against unintended loss of potentially important data. The delete zone 116 provides a memory space for managing removed components 304 during the optimization process, which allows for efficient handling of elements that may be eliminated or consolidated during image restructuring.

FIG. 3B illustrates example results of the adjustment process, showing both the structures of the initial image 102 and the optimized image 118. By applying the adjustment made to the modified image-layer adjustment graph 110 to the initial image 102, the dynamic image-layer adjustment module 108 aims to create an optimized container image with reduced size and improved deployment characteristics as compared to the initial image 102. The resulting structure of the optimized image 118 maintains the necessary functionality while eliminating redundancies and inefficiencies in the layer organization.

Returning again to FIG. 1, the container image optimization and deployment system includes a deployment platform 120. The deployment platform 120 can comprise a container-orchestration system that automates deployment, scaling, and management of applications using containers (referred to herein as “containerized applications”). Kubernetes^{®} is one example of an open source container-orchestration system. The Kubernetes^{®} container-orchestration system defines an architecture of clusters and pods for running applications using containers. A cluster is a set of node machines (also referred to as “worker nodes”) that execute pods. A pod is the smallest deployable unit of computing (an object that has a state, associated operations, and can be accessed by an identifier) defined by the container-orchestration system, and the pod comprises a group of one or more tightly coupled containerized applications that operate together. Although the present disclosure uses the term “pod” to refer to a grouping of one or more containerized applications, it will be understood that the aspects of the present disclosure are not limited to the Kubernetes^{®} container-orchestration system. Namely, as will be appreciated by persons of ordinary skill, the aspects of the present disclosure can be used with any appropriate container-orchestration system.

An optimized image 118, constructed as described above, is provided to the deployment platform 120. The deployment platform 120 then deploys a primary containerized application (shown as primary application 124) using the optimized image 118, and deploys a secondary containerized application (shown as secondary application 126) using an initial image 102, upon which the optimized image 118 is based. Both the primary application 124 and the secondary application 126 are deployed into a same pod 122. The primary application 124 and the secondary application 126 are started at the same time (i.e., started substantially at the same time, as will be appreciated by persons of ordinary skill).

The primary application 124 serves as the primary working application, and the secondary application 126 serves as a backup to the primary application 124. If the primary application 124 works properly, the secondary application 126 can be terminated, otherwise, in the event that the primary application 124 fails, the secondary application 126 will take over the operations of the primary application 124. This dual-containerized application approach allows for deployment flexibility and potential fallback options. Moreover, by deploying both a primary application 124 using an optimized image 118 and a secondary application 126 using an initial image 102, the system provides a robust deployment strategy. This approach allows for immediate use of the optimized image 118 while maintaining the ability to fall back to the initial image 102 if needed.

As illustrated, a service 114 component interfaces with the pod 122 containing the primary application 124 to collect performance information for the primary application 124. The service 114 provides the performance information to a deploy validation module 112 that monitors performance of the primary application 124 and validates the optimized image 118 via performance of the primary application 124. More specifically, the deploy validation module 112 monitors incoming user-requests to the primary application 124 and evaluates performance of the primary application 124 to handle the user-requests. As used herein, a “user-request” is either of a human generated request or a programmatically generated request. In some embodiments, the performance evaluation can be based on failed requests (e.g., if a threshold number of failed requests is met, validation of the optimized image 118 fails). In some embodiments, the performance evaluation can be based on various metrics (e.g., response time, throughput, error rate, resource utilization (CPU, memory, network), and latency).

In the event that the primary application 124 fails to perform adequately, the deploy validation module 112 instructs the secondary application 126 to take over incoming user-requests. In addition, the deploy validation module 112 can update the status of the optimized image 118 in a container image repository (not shown) to indicate a failed validation of the optimized image 118, and to initiate a restart of the container image optimization process.

However, if the primary application 124 is successfully validated, the deploy validation module 112 removes the secondary application 126 from the pod 122 (e.g., instructs the deployment platform 120 to delete the secondary application 126), such that the primary application 124 is retained as the working application for handling user-requests. The deploy validation module 112 also updates the status of the optimized image 118 in the container-image repository to indicate that the optimized image 118 is now the working container image for launching containerized applications. Also, updating the status of the optimized image 118 as the working container image causes, in some embodiments, removal of the initial image 102 from the container-image repository. In some embodiments, the initial image 102 can be retained for a period of time (e.g., archived).

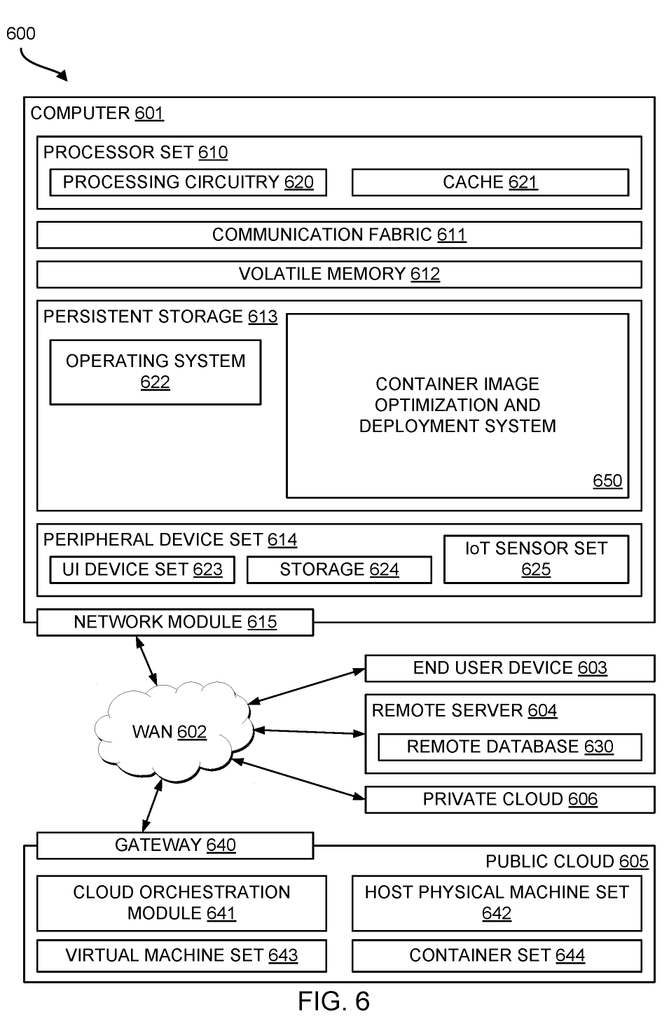

In the illustrative examples, the same reference numeral may be used in more than one figure. This reuse of a reference numeral in different figures represents the same element in the different figures. All or a portion of the container image optimization and deployment system shown in FIG. 1 can be implemented, for example by all or a subset of the computing environment 600 of FIG. 6. The components illustrated in FIG. 1 can be implemented in software, hardware, firmware or a combination thereof. When software is used, the operations performed by the components can be implemented in program instructions configured to run on hardware, such as a processor set. When firmware is used, the operations can be implemented in program instructions and data and stored in persistent memory to run on a processor set. When hardware is employed, the hardware can include circuits that operate to perform the operations.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices.

Generally, modules (also referred to as program modules) include routines, programs, components and/or data structures that perform particular tasks and/or implement particular abstract data types. In some embodiments, the modules described herein can be implemented as computing services hosted in a computing service environment (e.g., public or private cloud). For example, a module can be considered a service with one or more processes executing on a server or other computer hardware. Such services can provide a service application that receives requests and provides output to other services or consumer devices. An application programing interface (API) can be provided for each module to enable a first module to send requests to and receive output from a second module. Such APIs can also allow third parties to interface with the module and make requests and receive output from the modules. While FIGS. 1, 2A, 2B, 3A, and 3B, illustrate an example system that can implement the techniques above, many other similar or different systems are possible. The example system discussed and illustrated above is merely representative and not limiting.

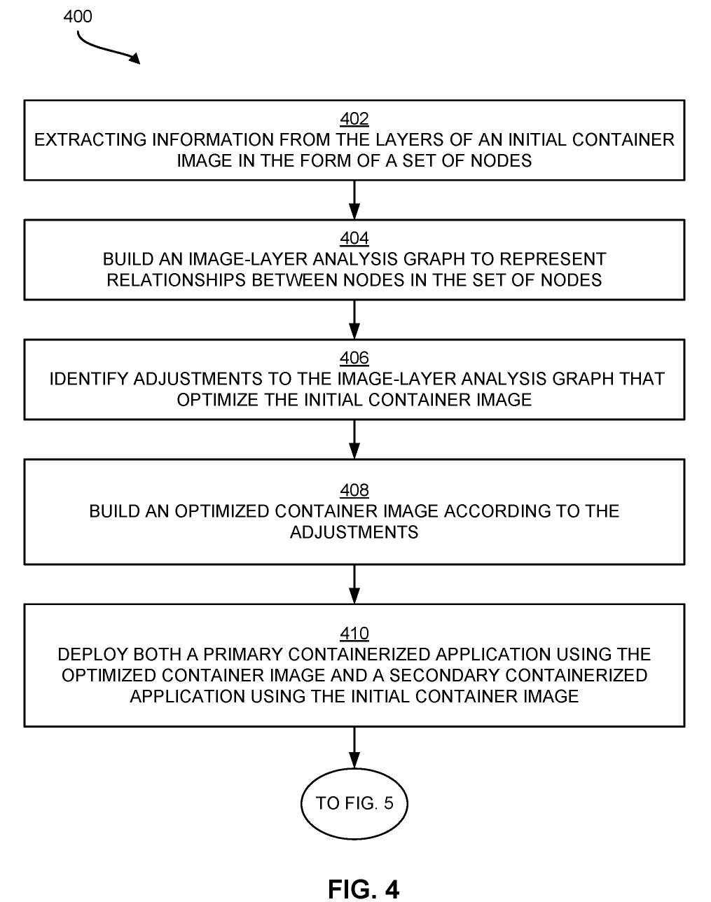

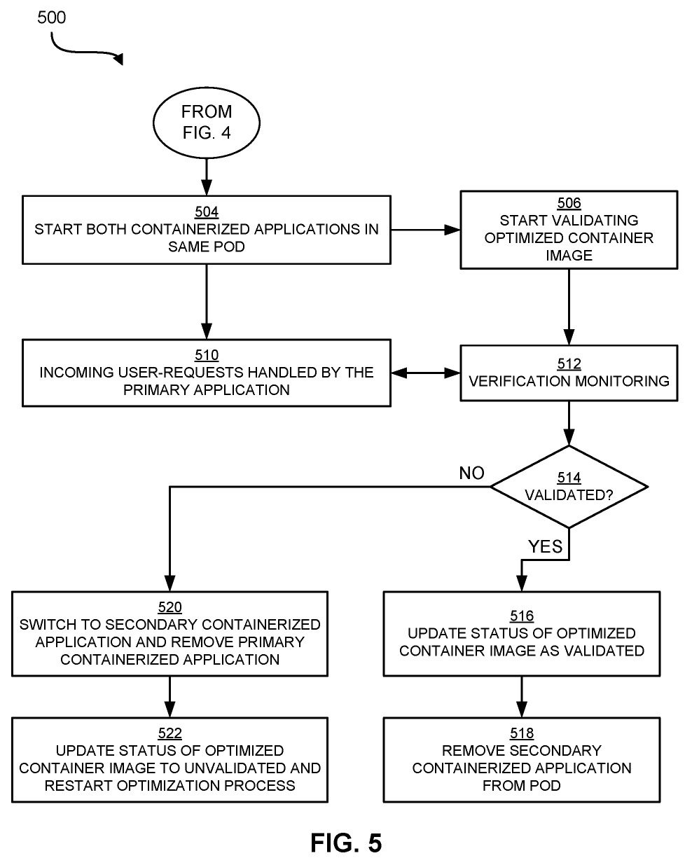

FIG. 4 is a flow diagram illustrating an example method 400 for container deployment acceleration, in accordance with some embodiments of the present disclosure. Starting with operation 402, the method 400 extracts information from the layers of an initial container image in the form of a set of nodes. The extraction can involve parsing the layer structure of the initial container image to obtain detailed information about the composition and characteristics of each layer. For example, original data of each layer can be extracted, including layer identifiers, file lists, and layer build commands. The information extracted from the layers can be represented in the form of a set of nodes, where each node corresponds to a specific element or attribute of the container image structure, as described in detail earlier.

In operation 404, the method 400 builds an image-layer analysis graph to represent relationships between the nodes in the set of nodes. Building the image-layer analysis graph includes analyzing the extracted information to identify relationships between the layers, relationships between the layers and files, and relationships between the files. The image-layer analysis graph, in some embodiments, serves as a visual representation of the relationships between the elements of the layers of the initial container image. The image-layer analysis graph highlights interconnections and dependencies between the different elements, such as relationships between layers, files, and commands. These relationships revealed by the image-layer analysis graph may show file-level redundancies, empty layers, intermediate files, as well as commands that are duplicative or redundant. By representing these relationships in a structured format, the image-layer analysis graph facilitates more efficient analysis and optimization of the container image.

In operation 406, the method 400 identifies potential adjustments to the image-layer analysis graph and formulates an adjustment plan that, when applied to the initial container image, is expected to improve the deploy-time of a containerized application. This process can involve evaluating the relationships and dependencies represented in the image-layer analysis graph to determine which adjustments may be most effective. The adjustments are identified by analyzing the relationships represented in the image-layer analysis graph. For example, analysis of the relationships may indicate that some layers, files, and/or commands are duplicative or redundant. Based on the results of the analysis, operations to optimize the initial container image are identified. Illustratively, these operations can include file deletion, command deletion, layer merging, layer deletion, layer relinking, base layer replacement, as well as other operations known by persons of ordinary skill. The adjustments of the adjustment plan aim to reduce the size of the initial container image, thereby potentially leading to a reduced container deploy-time.

In some embodiments, the method 400 includes modifying the image-layer analysis graph based on the adjustment plan. The modifications form a modified image-layer analysis graph that can be used to guide the construction of an optimized container image.

In operation 408, the method 400 builds an optimized container image according to the adjustment plan identified for the image-layer analysis graph. In some embodiments, building the optimized container image can comprise modifying the initial container image to correspond to the modified image-layer analysis graph. This process can include merging/deleting image layers, consolidating redundant files, and/or implementing a slimmer base layer. The result of this process is the creation of an optimized container image that maintains the necessary functionality of the initial container image while improving deployment characteristics of the initial container image.

In operation 410, the method 400 deploys a primary containerized application using the optimized container image, and a secondary containerized application using the initial container image. Both containerized applications are deployed to the same pod (e.g., a Kubernetes® pod) in a production environment, where the primary containerized application is set to service user-requests, and the secondary containerized application is set to serve as a backup to the primary containerized application.

This dual-container deployment approach provides a robust strategy for container deployment. By implementing both the optimized and initial container images in parallel, the method 400 leverages the benefits of the optimized container image while retaining the ability to fall back to the original, initial container image if needed. Thus, the method 400 allows for immediate use of the optimized container image to implement the primary containerized application, while maintaining system reliability through the secondary containerized application implemented using the original container image.

FIG. 5 is a flow diagram of an example method 500 for validating an optimized container image, in accordance with some embodiments of the present disclosure. The method 500 monitors and validates the performance of a deployed optimized container image by observing various metrics and behaviors to ensure the optimized container image functions as expected and meets predetermined performance thresholds.

As described above, the primary containerized application is deployed using the optimized container image, and the secondary containerized application is deployed using the initial (unoptimized) container image. Both the primary containerized application and the secondary containerized application are deployed to the same pod in a production environment. Because the optimized container image is based on the initial container image, both the primary containerized application and the secondary containerized application are configured to provide the same service, and as such, the containerized applications are interchangeable.

After deploying the primary and secondary containerized applications to the production environment, the method 500, in operation 504, starts both containerized applications in the same pod. The primary containerized application is set as the primary working application for handling user-requests, and the secondary containerized application acts as a backup to ensure continuity of service in case of issues with the primary containerized application that stem from the optimized container image.

In response to starting the primary containerized application, the method 500, in operation 506, starts validating the optimized container image, from which the primary containerized application was implemented. This validating is performed by monitoring performance of the primary containerized application. As described previously, a service can interface with a pod containing the primary containerized application to collect performance information for the primary containerized application. The service (shown as 114 in FIG. 1) can provide the performance information to a deploy validation module (shown as 112 in FIG. 1) that monitors and validates the performance of the primary containerized application.

In operation 510, the primary containerized application starts handling incoming user-requests, and in operation 512, the method 500 performs verification monitoring. The verification monitoring continuously observes the performance of the primary containerized application by tracking various metrics and behaviors to ensure the primary containerized application functions as expected and meets predetermined performance thresholds. In some embodiments, the method 500 monitors incoming user-requests handled by the primary containerized application to determine how well the primary containerized application handles the user-requests. Validation of the optimized container image is based on the primary containerized application’s ability to handle these user-requests.

In operation 514, the method 500 determines whether to validate the optimized container image. The optimized container image is validated when monitoring of the primary containerized application confirms that performance of the primary containerized application meets a performance threshold. In some embodiments, the performance threshold can be based on a threshold number of successfully, or unsuccessfully, handled user-requests over a period of time. In some embodiments, the performance threshold can be based on various metrics, including, but not limited to, response time, throughput, error rate, resource utilization (CPU, memory, network), and latency.

In the case that the optimized container image is validated, the method 500, in operation 516, updates the status of the optimized container image as validated. For example, a status maintained in a container image repository can be updated to indicate validation of the optimized container image, thereby allowing the optimized container image to be used for other deployments. Additionally, in operation 518, the method 500 removes (deletes) the secondary containerized application from the pod. That is, because the reliability and effectiveness of the optimized container image has been validated, the secondary containerized application is no longer needed as a backup and can be deleted.

In the case that the optimized container image is not validated, the method 500, in operation 520, switches operations to the secondary containerized application and removes (deletes) the primary containerized application from the pod. This failover mechanism ensures that the service provided by the pod remains operational when the primary containerized application fails due to an issue with the optimized container image. Additionally, in operation 522, the method 500 updates the status of the optimized container image to indicate that the optimized container image was not validated and that the image optimization process should be restarted. For example, a status maintained in a container image repository can be updated to indicate that validation of the optimized container image was not successful, and as such, the initial (original) container image should continue to be used for production deployments. Also, in some embodiments, a reason for the failure to validate the optimized container image can be identified (e.g., via log analysis), and the reason can be provided to the image optimization process to allow the reason to be considered during the next iteration of the image optimization process. In some cases, the container deployment process may iterate through multiple cycles of optimization, deployment, and verification. This iterative approach allows for continuous improvement of the container image and deployment efficiency over time.

The methods described above can be performed by a computer (e.g., computer 601 in FIG. 6), performed in a cloud environment (e.g., clouds 606 or 605 in FIG. 6), and/or generally can be implemented in fixed-functionality hardware, configurable logic, logic instructions, etc., or any combination thereof. With respect to the flow diagrams, depending upon the technology involved, the operations can be performed in a different order than what is shown in a given flow diagram. For example, again depending upon the technology involved, two operations shown in successive blocks may be performed in reverse order, as a single integrated step, concurrently, or in a manner at least partially overlapping in time. Also, other blocks can be added in addition to the illustrated blocks in the flow diagrams, as well as the block diagrams.

The various aspects of the present disclosure described herein by the narrative text, flow diagrams, block diagrams of computer systems and/or block diagrams of the machine logic can be included in computer program product (CPP) embodiments. A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage media or medium, as the terms are used in the present disclosure, are not to be construed as storage in the form of transitory signals per se. Namely, a computer-readable storage media or medium is not radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 600 contains an example of an environment for the execution of at least some of the computer code involved in performing the disclosed methods, such as computer code in block 650 for a container image optimization and deployment system. In addition to block 650, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 650, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer-readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as cache 621 and the other storage media discussed below. The computer-readable program instructions, and associated data, are accessed by processor set 610 to control and direct performance of the disclosed methods. In computing environment 600, at least some of the instructions for performing the disclosed methods may be stored in block 650 in persistent storage 613.

COMMUNICATION FABRIC 611 is the signal conduction paths that allow the various components of computer 601 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid-state storage devices. Operating system 622 may take several forms, such as various known proprietary operating systems or open-source Portable Operating System Interface type operating systems that employ a kernel. The code included in block 650 typically includes at least some of the computer code involved in performing the disclosed methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer-readable program instructions for performing the disclosed methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. The terms “comprises,” “comprising,” “includes,” “including,” “has,” “having,” “contains” or “containing,” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. The term “user” refers to an entity (e.g., an individual(s), a computer, or an application executing on a computer). It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. As used herein, “a set of” means one or more of an item or object being referenced. For example, a set of nodes is one or more nodes.

In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure. Note further that numerous aspects or features are disclosed herein, and unless inconsistent, each disclosed aspect or feature is combinable with any other disclosed aspect or feature as desired for a particular application of the concepts disclosed.

As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art. Any advantages discussed in the present disclosure are example advantages, and embodiments of the present disclosure can exist that realize all, some, or none of any of the discussed advantages while remaining within the spirit and scope of the present disclosure.

It will be further appreciated that various aspects of the present invention may be provided in the form of a service deployed on behalf of a customer to offer service on demand.

The descriptions of the various aspects of the present invention have been presented for purposes of illustration, but are not intended to be exhaustive or limited to the approaches disclosed. Many modifications and variations will be apparent to those of ordinary skill in the art without departing from the scope and spirit of the described aspects. The terminology used herein was chosen to best explain the principles of the various aspects described, the practical application or technical improvement over technologies found in the marketplace, or to enable others of ordinary skill in the art to understand the approaches disclosed herein.

What is claimed is:

1. A computer-implemented method, comprising:
extracting, by a processor set, information from layers of an initial container image in the form of a set of nodes;
building, by the processor set, an image-layer analysis graph to represent relationships between nodes in the set of nodes;
identifying, by the processor set, adjustments to the image-layer analysis graph that are expected to improve a containerized application deploy-time;
building, by the processor set, an optimized container image according to the adjustments identified for the image-layer analysis graph; and
deploying, by the processor set, a primary containerized application using the optimized container image, and a secondary containerized application using the initial container image, where the secondary containerized application serves as a backup to the primary containerized application.

2. The computer-implemented method of claim 1, wherein extracting the information from the layers of the initial image comprises:
parsing, by the processor set, the layers of the initial container image; and
extracting, by the processor set, original data from the layers, including layer identifiers, file lists, and layer build commands.

3. The computer-implemented method of claim 1, wherein building the image-layer analysis graph further comprises:
analyzing, by the processor set, the information to identify relationships between the layers, relationships between the layers and files, and relationships between the files.

4. The computer-implemented method of claim 1, wherein identifying the adjustments to the image-layer analysis graph comprises:
identifying, by the processor set, based on the relationships represented in the image-layer analysis graph, operations to optimize the initial container image, the operations selected from the group consisting of: layer merging, layer deletion, layer relinking, and base layer replacement.

5. The computer-implemented method of claim 1, further comprising:
modifying the image-layer analysis graph based on the adjustments identified as optimizing the initial container image to form a modified image-layer analysis graph, wherein building the optimized container image comprises modifying the initial container image to correspond to the modified image-layer analysis graph.

6. The computer-implemented method of claim 1, further comprising:
monitoring, by the processor set, performance of the primary containerized application implemented using the optimized container image; and
switching, by the processor set, to the secondary containerized application if the primary containerized application fails to perform above a predetermined threshold.

7. The computer-implemented method of claim 6, further comprising:
removing, by the processor set, the secondary containerized application after a determination that the primary containerized application is performing above the predetermined threshold.

8. A system for optimizing container deployment, comprising:
a processor set; and
a memory storing instructions that, when executed by the processor set, cause the system to:
extract information from layers of an initial container image in the form of a set of nodes;
build an image-layer analysis graph to represent relationships between nodes in the set of nodes;
identify adjustments to the image-layer analysis graph that, when applied to the initial container image, are expected to improve a containerized application deploy-time;
build an optimized container image according to the adjustments identified for the image-layer analysis graph; and
deploy a primary containerized application using the optimized container image and a secondary containerized application using the initial container image, where the secondary containerized application serves as a backup to the primary containerized application.

9. The system of claim 8, wherein extracting the information from the layers comprises:
parsing a layer structure of the initial container image; and
extracting original data from the layers, including layer identifiers, file lists, and layer build commands.

10. The system of claim 8, wherein building the image-layer analysis graph comprises:
analyzing relationships between layers and files; and
detecting file-level redundancies, empty layers, and intermediate files.

11. The system of claim 8, wherein identifying the adjustments to the image-layer analysis graph comprises:
generating a modified image-layer analysis graph based on the adjustments; and
determining layer merging, deletion, and relinking operations to optimize the initial container image.

12. The system of claim 11, wherein building the optimized container image according to the adjustments further comprises:
merging or deleting associated image layers based on the modified image-layer analysis graph;
replacing a base layer with a reduced version; and
caching deleted files in a delete zone.

13. The system of claim 8, wherein the instructions further cause the system to:
monitor performance of the primary containerized application; and
switch to the secondary containerized application in response to the primary containerized application failing to perform above a predetermined threshold.

14. The system of claim 13, wherein the instructions further cause the system to:
remove the secondary containerized application after a determination that the primary containerized application is performing above the predetermined threshold.

15. A computer-readable storage medium storing instructions that, when executed by a processor, cause the processor to perform operations comprising:
extracting information from layers of an initial container image in the form of a set of nodes;
building an image-layer analysis graph to represent relationships between nodes in the set of nodes;
identifying adjustments to the image-layer analysis graph that, when applied to the initial container image, are expected to improve a containerized application deploy-time;
building an optimized container image according to the adjustments identified for the image-layer analysis graph; and
deploying a primary containerized application using the optimized container image and a secondary containerized application using the initial container image, where the secondary containerized application serves as a backup to the primary containerized application.

16. The computer-readable storage medium of claim 15, wherein extracting the information from the layers comprises:
parsing a layer structure of the initial container image; and
extracting original data from the layers, including layer identifiers, file lists, and layer build commands.

17. The computer-readable storage medium of claim 15, wherein building the image-layer analysis graph comprises:
analyzing the information to identify relationships between the layers, relationships between the layers and files, and relationships between the files.

18. The computer-readable storage medium of claim 15, wherein identifying the adjustments to the image-layer analysis graph further comprises:
identifying, based on the relationships represented in the image-layer analysis graph, operations to optimize the initial container image, the operations selected from the group consisting of: layer merging, layer deletion, layer relinking, and base layer replacement.

19. The computer-readable storage medium of claim 15, wherein building the optimized container image further comprises:
modifying the image-layer analysis graph based on the adjustments identified as optimizing the initial container image to form a modified image-layer analysis graph, wherein building the optimized container image comprises modifying the initial container image to correspond to the modified image-layer analysis graph.

20. The computer-readable storage medium of claim 19, wherein the operations further comprise:
monitoring performance of the primary containerized application implemented using the optimized container image; and
switching to the secondary containerized application in response to the primary containerized application failing to perform above a predetermined threshold.
